(19) United States
(12) Patent Application Publication
(10) Pub. No.: US 2017/0160682 A1
(43) Pub. Date: Jun. 8, 2017

(54) IMAGE FIXING APPARATUS

(71) Applicant: CANON KABUSHIKI KAISHA, Tokyo (JP)

(72) Inventors: Yuki Nishizawa, Yokohama-shi (JP); Seiji Obata, Mishima-shi (JP); Hirotomo Tamiya, Kawasaki-shi (JP)

(21) Appl. No.: 15/371,837

(22) Filed: Dec. 7, 2016

(30) Foreign Application Priority Data
Dec. 8, 2015 (JP) 2015-239272

(51) Int. Cl. G03G 15/20

(52) U.S. Cl. CPC G03G 15/206

(57) ABSTRACT

An image fixing apparatus includes a cylinder including an electroconductive layer and having a hole at least an end; a driving member engaged with the end to rotate the cylinder and including a claw engaged with the hole; a coil inside the cylinder for forming an alternating magnetic field for heat generation of the layer, a magnetic core. The cylinder generates heat by a current flowing in a circumferential direction of the cylinder induced in the layer in the magnetic field, and wherein the cylinder is provided with a slit at the longitudinal end, the slit being disposed at a position different from a position of the hole with respect to the circumferential direction of the cylinder and overlapping the hole with respect to a longitudinal direction of the cylinder.

### FIELD OF THE INVENTION AND RELATED ART

The present invention relates to an image heating device which is preferable as a fixing device to be mounted in an image forming apparatus such as an electrophotographic copying machine, an electrophotographic printing machine, and the like. It relates also to a cylindrical rotational member to be employed by the image heating device.

A heating device based on electromagnetic induction has long been known as a fixing device to be mounted in an image forming apparatus such as an electrophotographic copying machine, an electrophotographic printing machine, and the like. This type of heating device has an excitation coil, a fixation roller in which heat is generated by the magnetic flux generated by the excitation coil, and a pressure roller which forms a nip by being pressed on the fixation roller. A sheet of recording medium on which an unfixed toner image is borne is heated while it is conveyed through the nip, remaining pinched between the fixation roller and pressure roller. Consequently, the toner image is fixed to the sheet.

This type of fixing device heats its fixation roller which is a piece of pipe with thin wall, being therefore small in thermal capacity. Thus, it is advantageous in that it can reduce an image forming apparatus in the length of warm-up time.

A fixing device which employs a piece of pipe with thin wall is structured so that its driving gear is fixed to one of the lengthwise ends of its fixation roller. More specifically, the inner surface of the driving gear, which is in the form of a ring, is provided with a protrusion shaped like a key, whereas the corresponding end of the fixation roller is provided with such a slot that matches in shape the key of the driving gear. Thus, as the lengthwise end of the fixation roller, which has the slot, is inserted into the driving gear to fix the driving gear to the fixation roller, the key of the driving gear fits into the slot of the fixation roller.

There are disclosed fixing devices which use a heating method based on electromagnetic induction, in Japanese Laid-open Patent Applications Nos. 2000-81806, 2014-26267, and 2003-330291. The fixing device disclosed in Japanese Laid-open Patent Applications No. 2000-81806 has: a fixation roller, the electrically conductive layer of which is made of magnetic metal such as iron, nickel, etc., which is easily permeable by magnetic flux; a spiral excitation coil disposed in the hollow of the fixation roller, in parallel to the axial line of the fixation roller, in order to guide the magnetic flux generated by a magnetic field generating means, to the conductive layer of the fixation roller. As the magnetic flux is guided into the conductive layer of the fixation roller, it generates eddy current primarily inside the conductive layer, generating thereby heat (Joule's heat) in the conductive layer. Consequently, the fixation roller is heated.

As for the fixing device disclosed in Japanese Laid-open Patent Application No. 2014-26267, it has a spiral excitation coil disposed in the hollow of the fixation roller, in parallel to the axial line of the fixation roller, and a magnetic core disposed in the hollow of the spiral excitation coil to guide the magnetic flux generated by the magnetic field generating means in such a manner that the magnetic flux does not go through the conductive layer of the fixation roller.

That is, the fixing device is considered as a magnetic circuit. Then, the state, which can serve as an index for indicating the level of easiness with which magnetism can permeate the magnetic circuit in the direction parallel to the lengthwise direction of the fixation roller, is created. That is, regarding the “magnetic resistance in terms of the lengthwise direction of the fixation roller”, such a state that “magnetic resistance of the magnetic core” is negligibly small in terms of the lengthwise direction, and the magnetic resistance of the fixation roller in terms of its lengthwise direction, and the magnetic resistance of the inward side of the fixation roller in terms of the lengthwise direction of the fixation roller are satisfactorily large. Whereby, it is possible to design a fixing device in which magnetic flux is concentrated into the magnetic core, and does not go through the fixation roller and the inward side of the fixation roller.

The conductive layer of the fixation roller is subjected to such voltage that works in the circumferential direction of the fixation roller. Thus, heat (Joule's heat) is efficiently generated by the circular current generated by the voltage. Compared to the method disclosed in Japanese Laid-open Patent Application No. 2000-81806, this method does not require that the magnetic flux is guided to the conductive layer of the fixation roller. Therefore, it is meritorious in that it is free from the requirements regarding the thickness of the conductive layer, and the material for the conductive layer.

A fixing device is intended to heat a sheet of recording medium. Therefore, it is desired that a fixing device is as small as possible in the amount by which it generates heat in its portions which are out of the path of a sheet of recording medium (this portions may be referred to as “out-of-sheet-path areas”, hereafter). There is disclosed in Japanese Laid-open Patent Application No. 2003-330291, a fixing device, the out-of-sheet-path portions of the conductive layer of the rotational heating member of which are provided with slots for preventing the out-of-sheet-path portions from generating heat.

However, a fixing device structured so that its driving gear and fixation roller are provided with a key (protrusion) and a slot (key slot), respectively, and also, so that as the driving gear is attached to (fitted around) one of the lengthwise ends of the fixation roller, the key fits into the slot, suffers from the following issue. That is, as the driving gear is rotated by the meshing of the driving gear with another gear from which driving force is transmitted to the driving gear, the portions of the lengthwise end portions which is adjacent to the key slot of the lengthwise end portion of the fixation roller are subjected to such stress that tends to widen the key slot. This stress acts on the lengthwise end of the fixation roller in a manner to bend the adjacencies of the key slot outward in terms of the radius direction of the fixation roller, that is, in a manner to widen the key slot. In other words, this setup makes the lengthwise end portion of the fixation roller insufficient in mechanical strength, making therefore the lengthwise end portion of the fixation roller susceptible to damage. Further, the portion of the lengthwise end portion of the fixation roller, which is adjacent to the inward end of the key slot, is likely to be split by the stress which works in a manner to bend the portions of the fixation roller, which are adjacent to the key slot, outward in terms of the radius direction of the fixation roller. Therefore, it was necessary to increase a fixation roller in the thickness of its wall, in order to strengthen the fixation roller.

This solution, however, was problematic in that increasing a fixation roller in the thickness of its wall increases the fixation roller in thermal capacity, which in turn increases the fixation roller in the length of time it takes to warm up the fixation roller, which in turn increases the fixing device in power consumption.

Further, regarding the prevention of the heat generation in the out-of-sheet-path portions of the fixation roller, a fixing device such as the one disclosed in Japanese Laid-open Patent Application No. 2014-26267 suffers from the following problem. That is, if the out-of-sheet-path portions of the conductive layer of a fixation roller is provided with a slot which extends in the direction parallel to the axial line of the fixation roller, and voltage is applied to the conductive layer of the fixation roller, in the circumferential direction of the conductive layer, the current induced by the voltage flows in a manner to circumvent the slot (this current may be referred to as “circumventive current”). Consequently, the circumventive current concentrates into the adjacencies of the inward end of the slot.

Thus, the adjacencies of the inward end of the slot, into which the circumventive current concentrates, increases the amount by which heat is generated. That is, it becomes higher in temperature than the other portions of the fixation roller, making it possible that the key portion (protrusion) of the driving gear will be reduced in mechanical strength by the heat generated in the out-of-sheet-path portion, and/or the heat generated in the adjacencies of the inward end of the slot by the circumventive current. Therefore, it is possible that the key portion (protrusion) of the driving gear will break.

One of the possible solutions to this problem is to provide the lengthwise end portions of the fixation roller with multiple slots, and distribute the slots in the circumferential direction of the fixation roller, in order to prevent the circumventive current from concentrating to the adjacencies of the inward end of a single slot. This setup also possibly reduces the lengthwise end portions of the fixation roller 51a in mechanical strength. In particular, in a case of a fixing device structured so that one of the lengthwise ends of its fixation roller is fitted with a driving gear to rotationally drive the fixation roller, reduction in the mechanical strength of the lengthwise ends of the fixation roller possibly leads to such a problem as the damage to the fixation roller.

Thus, the primary object of the present invention is to provide a cylindrical rotational member which is superior to any conventional one in that the lengthwise end portion of its conductive layer, to which a driving member is attached, is significantly less likely to be damaged than the counterpart of the conventional one, and an image heating device equipped with this cylindrical rotational member.

### SUMMARY OF THE INVENTION

According to an aspect of the present invention, there is provided a fixing apparatus for forming an image on a recording material, said fixing apparatus comprising a cylindrical rotatable member including an electroconductive layer and provided with a hole portion at least at one of longitudinal end portion; a driving member engaged with the longitudinal end portion of said rotatable member and configured to rotate said rotatable member, said driving member being provided with a claw portion engaged with said hole portion of said rotatable member; a coil provided inside said rotatable member and configured to form an alternating magnetic field capable of causing electromagnetic induction heat generation of said electroconductive layer, said coil including a helical configuration portion having a helicity axis extending along a generatrix direction of said rotatable member; a magnetic core provided inside said helical configuration portion, wherein said rotatable member generates heat by a current flowing in a circumferential direction of said rotatable member induced in said electroconductive layer in the alternating magnetic field, and wherein said rotatable member is provided with a slit at the longitudinal end portion, said slit being disposed at a position different from a position of said hole portion with respect to the circumferential direction of said rotatable member and overlapping said hole portion with respect to a longitudinal direction of said rotatable member.

Further features of the present invention will become apparent from the following description of exemplary embodiments with reference to the attached drawings.

### BRIEF DESCRIPTION OF THE DRAWINGS

FIG. 1 is a sectional view of an example of image forming apparatus to which the present invention is applicable.

FIG. 2 is a sectional view of a fixing device in accordance with the present invention.

FIG. 3 is a drawing for describing the fixation roller and driving gear of the fixing device, shown in FIG. 2.

FIG. 4 is a drawing for describing how the driving gear is attached to the fixation roller.

FIG. 5 is a drawing for describing how a roller cap is attached to the fixation roller.

FIG. 6 is a perspective view of a modified version of the combination of the fixation roller and driving gear shown in FIG. 3.

FIG. 7 is a sectional view of a combination of the fixation roller, and a heating means disposed in the hollow of the fixation roller.

FIG. 8 is a perspective cutaway view of the fixation roller.

FIG. 9 is a drawing for describing the heat generation mechanism which generates heat in the conductive layer of the fixation roller.

Part (a) of FIG. 10 is an electric circuit which is equivalent in current flow to the conductive layer of a slot-less fixation roller 51a, through which current is flowing in the circumferential direction of the conductive layer, and part (b) of FIG. 10 is a circuit which is equivalent in current flow to the conductive layer, through which current is flowing in the direction perpendicular to the lengthwise direction of the conductive layer, if it is assumed that the conductive layer is extended (opened) flat by being cut along a straight line perpendicular to the axial line of the fixation roller.

Part (a) of FIG. 11 is an electrical circuit which is equivalent in current flow to the conductive layer of a slotted fixation roller 51a, through which current is flowing in the circumferential direction of the conductive layer, and part (b) of FIG. 11 is a circuit which is equivalent in current flow to the conductive layer, through which current is flowing in the direction perpendicular to the lengthwise direction of the conductive layer, if it is assumed that the conductive layer is extended (opened) flat by being cut along a straight line perpendicular to the axial line of the fixation roller.

FIG. 12 is an electric circuit, in which part (b) of FIG. 11 results if the five areas of the conductive layer in part (b) of FIG. 11 are substituted by electrical resistances.

FIG. 13 is an electric circuit equivalent to the conductive layer of the slotted fixation roller of a fixing device when current is flowing in the circumferential direction of the fixation roller, in a manner to circumvent the slot through the adjacencies of the inward end of the slot.

Part (a) of FIG. 14 is an electric circuit which is equivalent to the conductive layer of a fixation roller, the lengthwise end portions of which are provided with multiple slots, when current is flowing though the conductive layer in the circumferential direction of the fixation roller, and part (b) of FIG. 14 is an electric circuit which is equivalent to the conductive layer of the fixation roller, the lengthwise end portions of which are provided with a combination of slots and holes, when current is flowing through the conductive layer in the circumferential direction of the conductive layer.

FIG. 15 is a drawing for describing the relationship between the circumventive current, and the area of the conductive layer, through which the circumventive current flows.

FIG. 16 is a drawing for describing the relationship between the positioning and shape of the holes and slots with which the lengthwise end portions of the fixation roller are provided, and the areas of the conductive layer, through which current flows to circumvent the slots and holes.

FIG. 17 is a drawing for describing the relationship between the shape and width of the slots and holes with which the lengthwise end portions of the fixation roller are provided, and the areas of the conductive layer, through which circumventive current flows.

### DESCRIPTION OF THE EMBODIMENTS

Hereinafter, a few of the preferred embodiments of the present invention are described with reference to appended drawings. The following embodiments of the present invention are the most preferable embodiments of the present invention. However, these embodiments are not intended to limit the present invention in scope. That is, the present invention is also applicable to various known fixing devices and image forming apparatuses which are different in structure from those in the following embodiment, within the scope of the present invention.

### Embodiment 1

### (1) Image Forming Apparatus 100

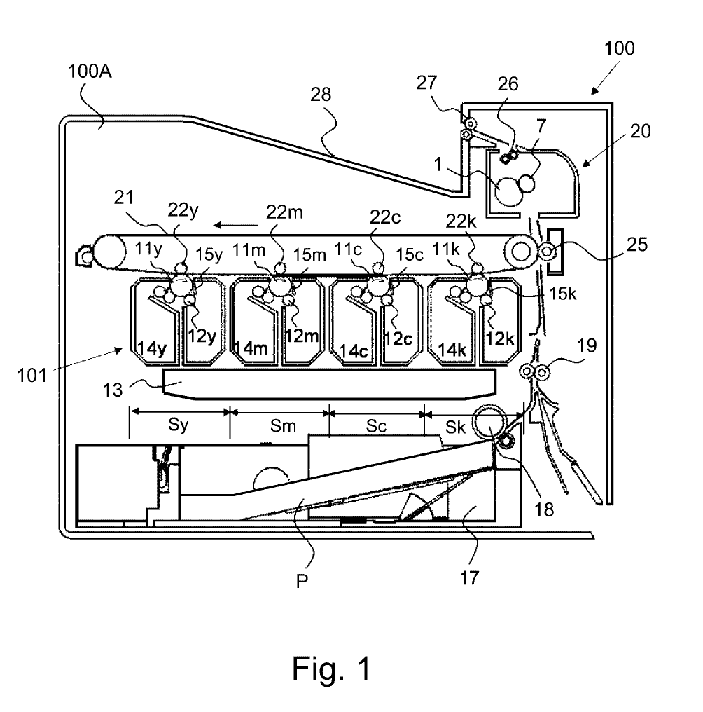

Referring to FIG. 1, an image forming apparatus equipped with an image heating device, as a fixing device, which is in accordance with the present invention is described. FIG. 1 is a sectional view of an image forming apparatus 100 (full-color printer) based on electrophotographic recording technologies. It shows the general structure of the apparatus.

The image forming portion 101 of the image forming apparatus 100, which is for forming a toner image on a sheet P of recording medium, has four image formation stations Sy, Sm, Sc and Sk, which form yellow, magenta, cyan, and black toner images, respectively.

Each image forming station has: photosensitive drums 11y, 11m, 11c and 11k as image bearing members; and charging members 12y, 12m, 12c and 13k. Further, each image forming station has: a laser scanner 13; developing devices 14y, 14m, 14c and 14k; and cleaners 15y, 15m, 15c and 15k which clean the photosensitive drums 11y, 11m, 11c and 11k, respectively. Moreover, each image forming station has: transferring members 22y, 22m, 22c and 22k; a belt 21, onto which toner images are transferred from the photosensitive drums by the transferring members, and which conveys the transferred toner images thereon, to a secondary transferring member 25 which transfers the toner images onto a sheet P of recording medium from the belt 12; etc.

The operation of the above described image forming portion 101 has been well-known, and therefore, is not described here in detail.

Sheets P of recording medium stored in a recording medium cassette 17 in the main assembly 100A of the image forming apparatus 100 are fed one by one into the main assembly 100A, by the rotation of a roller 18. Then, each sheet P is conveyed by the rotation of a pair of rollers 19 to a secondary transfer nip, which is the area of contact between the belt 17 and the secondary transfer roller 25. After the transfer of the toner images onto the sheet P, the sheet P is sent to a fixing device 20 (fixing portion).

Then, the sheet P which is bearing the unfixed toner images T is heated by the fixing device 20, whereby the toner images T are fixed to the sheet P. After being conveyed out of the fixing device 20, the sheet P is discharged into a delivery tray 28 by the rotation of a pair of rollers 26 and the rotation of a pair of rollers 27.

### (2) Fixing Device 20 (Image Heating Device)

### 2-1) General Structure

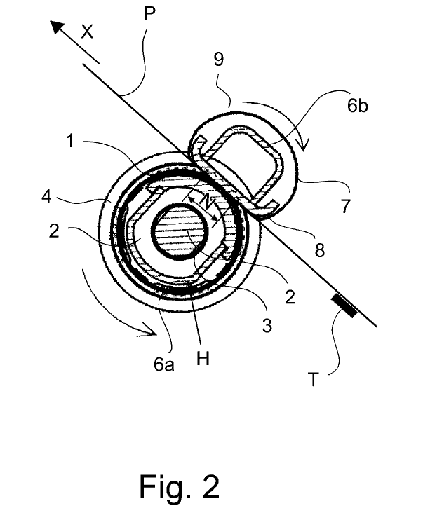

FIG. 2 is a sectional view of the fixing device 20 in this embodiment, which uses a heating method based on electromagnetic induction. It shows the general structure of the device 20. The fixing device 20 has: a cylindrical fixation roller 1 as a cylindrical rotational member; a heating means H which comprises a combination of a magnetic core 2 and an excitation coil 3, which is for heating the fixation roller; and a pressure application unit 9 equipped with a pressure belt 7, as a nip forming member, which is pressed upon the fixation roller to form a nip N.

The fixation roller 1 is rotatably supported. It is heated by the heating means H disposed in the hollow of the fixation roller 1. It is rotationally driven by an unshown motor in the direction indicated by an arrow mark by way of a driving gear 4. As for the pressure belt 7, it is rotated in the direction indicated by another arrow mark by the rotation of the fixation roller 1. A sheet P of recording medium which is bearing an unfixed toner images T is heated in the nip N while being conveyed through the nip N, remaining pinched between the fixation roller 1 and pressure belt 7. Consequently, the toner images T are fixed to the surface of the sheet P. Referring to FIG. 2, a referential code X stands for the direction in which the sheet P is conveyed.

There is no specific restriction regarding the shape and structure of the heating means H. All that is required of the heating means H is that it is shaped and structured so that it can be disposed in the hollow of the fixation roller 1. The choice of the heating means H may be made according to the purposes for which the heating means H is used. For example, a halogen lamp or the like may be chosen as the heating means H.

### 2-2) Fixation Roller 1 (Cylindrical Rotational Member)

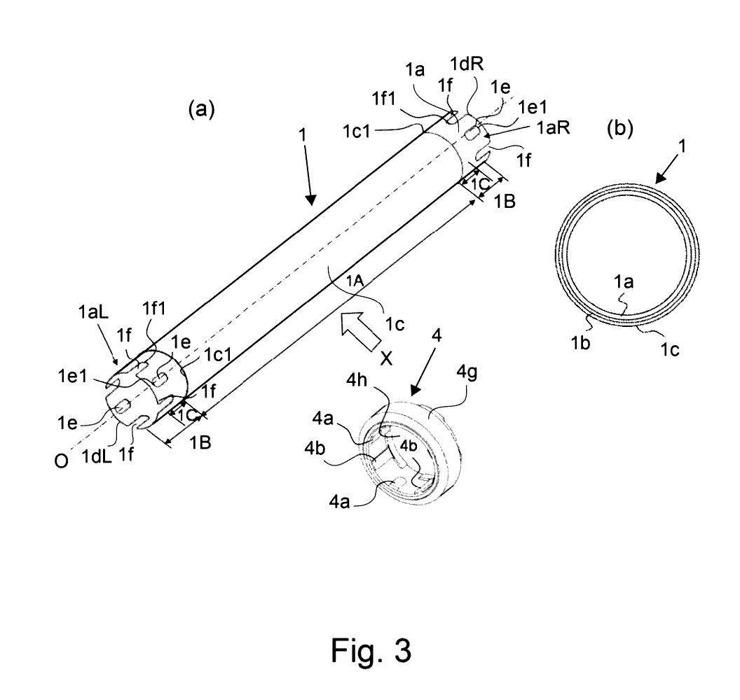

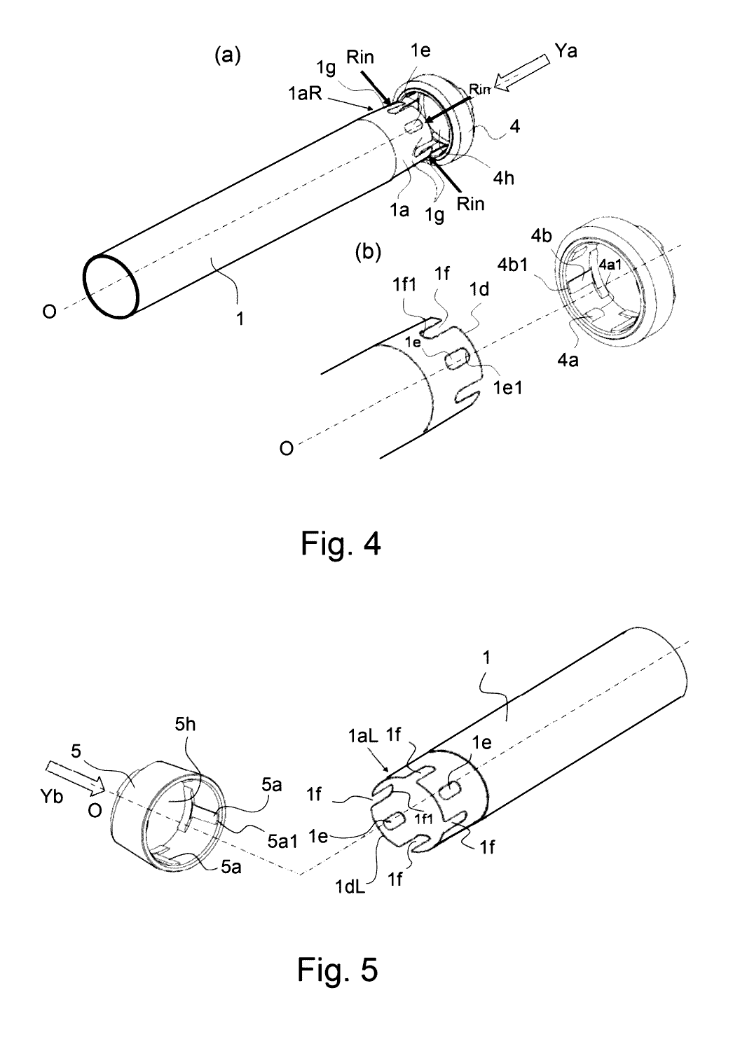

Part (a) of FIG. 3 is a perspective view of a combination of the fixation roller 1 and driving gear 4. Part (b) of FIG. 3 is a sectional view of the fixation roller 1. It shows the laminar structure of the fixation roller 1. Part (a) of FIG. 4 is an exploded perspective view of the combination of the fixation roller 1 and driving gear 4. It shows how the driving gear 4 is attached to the fixation roller 1. Part (b) of FIG. 4 is an enlarged and exploded perspective view of a combination of the driving gear 4, and the lengthwise end portion of the fixation roller 1, to which the driving gear 4 is attached. It shows the shape of the keys (protrusions) with which the driving gear 4 is provided, and the shape of slots (as key slots) with which the lengthwise end of the fixation roller 1 is provided to accommodate the keys (protrusions) one for one.

Referring to part (b) of FIG. 3, the fixation roller 1 has: a cylindrical conductive layer 1a; an elastic layer 1b formed on the peripheral surface of the conductive layer; and a surface layer 1c (release layer) formed on the peripheral surface of the elastic layer 1b.

The conductive layer 1a is a piece of pipe having a thin wall (0.1 mm-1.0 mm in thickness), and is formed of austenitic stainless steel. As the material for the conductive layer 1a, a substance having such a specific resistance that can make the conductive layer 1a generate a sufficient amount of heat based on electromagnetic induction, should be selected. The elastic layer 1b is formed of such silicone rubber that is 20 degrees in hardness (JIS-A, under 1 kg of weight). It is 0.1 mm-0.8 mm in thickness. The surface layer 1c, as a release layer, is a piece of fluorine resin tube. It covers the elastic layer 1b, and is 10 μm-50 μm in thickness.

Referring to part (a) of FIG. 3, in terms of the lengthwise direction of the fixation roller 1, which is perpendicular to the recording medium conveyance direction X, the right end portion 1aR of the conductive layer 1a, which is on the outward side of the recording medium path A, is provided with multiple holes 1e, which are roughly evenly distributed in the circumferential direction of the conductive layer 1a. Further, the right end portion 1aR of the conductive layer 1a is provided with multiple slots 1f, which also are roughly evenly distributed in the circumferential direction of the conductive layer 1a, in such a manner that the slots and the abovementioned holes are alternately disposed in terms of the circumferential direction of the conductive layer 1a. Each slot 1f extends in the lengthwise direction of the conductive layer 1a from the right end of the conductive layer 1a so that its inward end aligns with the inward end of the adjacent holes 1e in terms of the circumferential direction of the conductive layer 1a. Here, the right end portion 1aR of the conductive layer 1a is the area between the right end 1dR of the conductive layer 1a and the right end 1c1 of the surface layer 1c. That is, it is one of the out-of-sheet-path areas 1B.

Further, the left end portion 1aL of the conductive layer 1a (opposite end portion of the conductive layer 1a from the right end portion 1aR), which is on the outward side of the recording medium path A, is provided with multiple holes 1e, which are roughly evenly distributed in the circumferential direction of the conductive layer 1a. Further, the left end portion 1aL of the conductive layer 1a is provided with multiple slots 1f, which also are roughly evenly distributed in the circumferential direction of the conductive layer 1a, in such a manner that the slots and the abovementioned holes are alternately disposed in terms of the circumferential direction of the conductive layer 1a. Each slot 1f extends in the lengthwise direction of the conductive layer 1a from the left end 1dL of the conductive layer 1a so that its inward end aligns with the inward end of the adjacent holes 1e in terms of the circumferential direction of the conductive layer 1a. Here, the left end portion 1aL of the conductive layer 1a is the area between the left end 1dL of the conductive layer 1a and the left end 1c1 of the surface layer 1c. That is, it is also the out-of-sheet-path area 1B.

The holes 1e and slots 1f, with which the right and left end portions 1aR and 1aL, respectively, of the conductive layer 1a are provided are shaped and disposed so that their lengthwise direction is perpendicular to the recording medium conveyance direction X.

Regarding the right and left end portions 1aR and 1aL of the conductive layer 1a, in this embodiment, they are provided with four holes 1e and four slots 1f, which are 4.0 mm in width (dimension in terms of direction perpendicular to circumference direction of the conductive layer 1a). Referring to part (a) of FIG. 3, therefore, they are not contiguous in terms of the circumferential direction of the conductive layer 1a, except for the areas 1C, which are provided with neither the holes 1e nor slots 1f. Here, the area 1C is the area of the conductive layer 1a, which is between the farthest lengthwise end 1e1 of a hole 1e from the right end 1dR, (or the farthest lengthwise end 1f1 from the right end 1dR of the conductive layer 1a), and the corresponding lengthwise end 1c1 of the surface layer 1c.

It is the right end portion 1aR of the conductive layer 1a that the driving gear 4, as a driving member, is attached. The teeth portion 4g of the driving gear 4, which are on the outward side of the driving gear 4, meshes with the teeth portions of a gear by which the conductive layer 1a of the fixation roller 1 is rotationally driven. The driving gear 4 is a bevel gear. It is shaped so that as the driving gear 4 is rotationally driven, the driving force from the motor works on the driving gear 4 in a manner to press the driving gear 4 in the direction O which coincides with the axial line of the conductive layer 1a. Therefore, as the driving force is transmitted to the driving gear 4, the conductive layer 1a shifts in position with the driving gear 4 in the direction parallel to the axial line O of the conductive layer 1a (fixation roller 1).

Next, the configuration of the fixation roller 1 and driving gear 4, which is for attaching the driving gear 4 to the fixation roller 1, is described. Referring to part (a) of FIG. 3, the driving gear 4 is in the shape of a ring. That is, it has a cylindrical hole 4h which is slightly larger in diameter than the external diameter of the conductive layer 1a. Therefore, the right end portion 1aR of the conductive layer 1a can be pushed into the cylindrical hole 4h of the driving gear 4. The inner surface of the driving gear 4 is provided with multiple claws 4a and multiple ribs 4b, which function like keys. These claws 4a and ribs 4b are positioned so that they can be aligned with the holes 1e and slots 1f, respectively, when the fixation roller 1 (conductive layer 1a) is inserted into the driving gear 4.

The driving gear 4 is attached to the fixation roller 1 in the following manner. First, the fixation roller 1 and driving gear 4 are positioned so that their rotational axis coincide, and the claws 4a and ribs 4b align with the holes 1e and slots 1f, respectively. Then, the driving gear 4 is to be fitted around the right end portion 1aR of the conductive layer 1a from the direction indicated by an arrow mark Y, in the direction parallel to the axial line O. Referring to part (a) of FIG. 4, during this process, the portion 1g of the right end portion 1aR of the conductive layer 1a, which is adjacent to each hole 1e, is to be kept flexed inward Rin in terms of the radius direction of the fixation roller 1 (conductive layer 1a). As each hole 1e and corresponding claw 4a coincide in terms of the direction parallel to the axial line O, the projection 4a fits into the corresponding hole 1e, allowing the portion 1g of the right end portion 1aR, which is adjacent to the hole 1e, to straighten.

In terms of the direction Ya in which the driving gear 4 is moved to be fitted around the conductive layer 1a, the position of the driving gear 4 is determined by the contact between the inward end 4b1 of the rib 4b of the right end portion 1aR of the conductive layer 1a, shown in part (b) of FIG. 4, and the farthest end 1f1 of the slot 1f from the lengthwise end 1dR. That is, in terms of the direction Ya in which the driving gear 4 is moved to be fitted around the conductive layer 1a, the rib 4b extends inward of the conductive layer 1a (fixation roller 1) from the lengthwise right end 1dR, far enough to come into contact with the farthest surface 1f1 of the slot 1f from the lengthwise right end 1dR, as the driving gear 4 is moved in the direction Y to be fitted around the conductive layer 1a.

As for the position of the driving gear 4 in terms of the opposite direction from the direction Ya in which the driving gear 4 is moved to be fitted around the conductive layer 1a, it is determined by the contact between the opposite end 4a1 of the claw 4a from the right end 1dR of the conductive layer 1a, and the closest end 1e1 of the hole 1e from the right end 1dR. That is, in terms of the direction Y in which the driving gear 4 is moved to be fitted around the conductive layer 1a, the claw 4a extends long enough to come into contact with the farthest end 1e1 of the hole 1e from the lengthwise end 1dR of the conductive layer 1a.

Thus, the multiple claws 4a and ribs 4b, with which the driving gear 4 is provided, fit into the multiple holes 1e and slots 1f, respectively, with which the right end portion 1aR of the conductive layer 1a are provided. Thus, the driving force from the motor is transmitted from the driving gear 4 to the conductive layer 1a by way of both the edges of these holes 1e and the edges of the slots 1f.

As described above, as the driving gear 4 is fitted around the right end portion 1aR of the fixation roller 1, the multiple claw 4a and multiple rib 4b of the driving gear 4 fit into the corresponding holes 1e and slots 1f of the fixation roller 1, whereby the driving gear 4 is precisely positioned relative to the fixation roller 1 in terms of both the direction Ya in which the driving gear 4 is moved to be fitted around the fixation roller 1, and the opposite direction from the direction Y. Therefore, the fixing device 20 in this embodiment is superior to any conventional fixing device, in terms of the accuracy in the positional relationship between the fixation roller 1 and driving gear 4 in terms of the lengthwise direction of the fixation roller 1. Further, in terms of the direction Ya in which the driving gear 4 is moved to be fitted around the fixation roller 1, the area of contact between the edge of the hole 1e of the fixation roller 1, and the claw 4a, and the area of contact between the edge of the slot 1f of the fixation roller 1, through which the driving force is transmitted from the driving gear 4 to the fixation roller 1 remain the same in position in terms of the direction Ya. Therefore, the amount of the stress to which the edge of the hole 1e and the edge of the slot 1f of the fixation roller 1 are subjected as the driving force is transmitted to the fixation roller 1 remains stable. Therefore, right end portion 1aR of the conductive layer 1a is unlikely to be damaged by the stress.

Shown in Table 1 are how the driving gear 4 is attached to the fixation roller 1, and the results of tests (simulations) carried out to measure the maximum amount of stress to which the fixation roller 1 is subjected as driving force is transmitted to the fixation roller 1 from the driving gear 4. More specifically, Table 1 shows the calculated results of the analysis of the simulations (tests), in terms of elasticity-plasticity analysis, regarding large amount of deformation/limited slippage.

TABLE 1

| | Number of | Number of | Max. stress |
|---|---|---|---|
| | engaging | engaging | of roller |
| | claws | protrusions | [MPa] |
| Conventional | 0 | 8 | 315 |
| structures | | | |
| Embodiment | 4 | 4 | 230 |

Referring to Table 1, compared to a comparative example of fixing device, which is structured so that driving force is transmitted to the fixation roller 1 by only the ribs, the fixing device 20 in this embodiment is smaller in the amount of the stress to which the fixation roller 1 is subjected. By the way, the results given in Table 1 are those which are obtainable only when the areas of contact between the fixation roller 1 and driving gear 4 are stable in position in terms of the lengthwise direction of the fixation roller 1. In comparison, the comparative example of fixing device, which relies only on the ribs to transmit driving force, is unstable in the position of the areas of contact between the ribs of the driver gear 4 and the fixation roller 1 in terms of the lengthwise direction of the fixation roller 1. Therefore, the comparative fixing device is substantially larger in the maximum amount of stress to which the fixation roller 1 is subjected as driving force is transmitted to the fixation roller 1.

In this embodiment, it was in a case where the fixing device 20 is structured so that the four holes 1e and four slots 1f are evenly distributed in the circumferential direction of the fixation roller 1, and the holes 1d and slots 1f are alternately positioned in terms of the circumferential direction of the fixation roller 1, that the amount of the stress to which the fixation roller 1 is subjected when driving force is transmitted from the driving gear 4 to the fixation roller 1 is smallest. However, the best shape for the holes 1e and slots 1f, and the positioning of the holes 1e and slots 1f, are affected by the material, size, and wall thickness of the fixation roller 1. Therefore, their shape and positioning are desired to be determined based on the structure of the fixation roller 1.

In this embodiment, the driving force is transmitted to the fixation roller 1 by the multiple claws 4a and multiple ribs 4b with which the driving gear 4 is provided. However, effects similar to those obtained by this embodiment can be obtained even if the driving gear 4 is provided with no rib 4b, or the number of the ribs 4b are different from the number of the holes 1e with which the fixation roller 1 is provided.

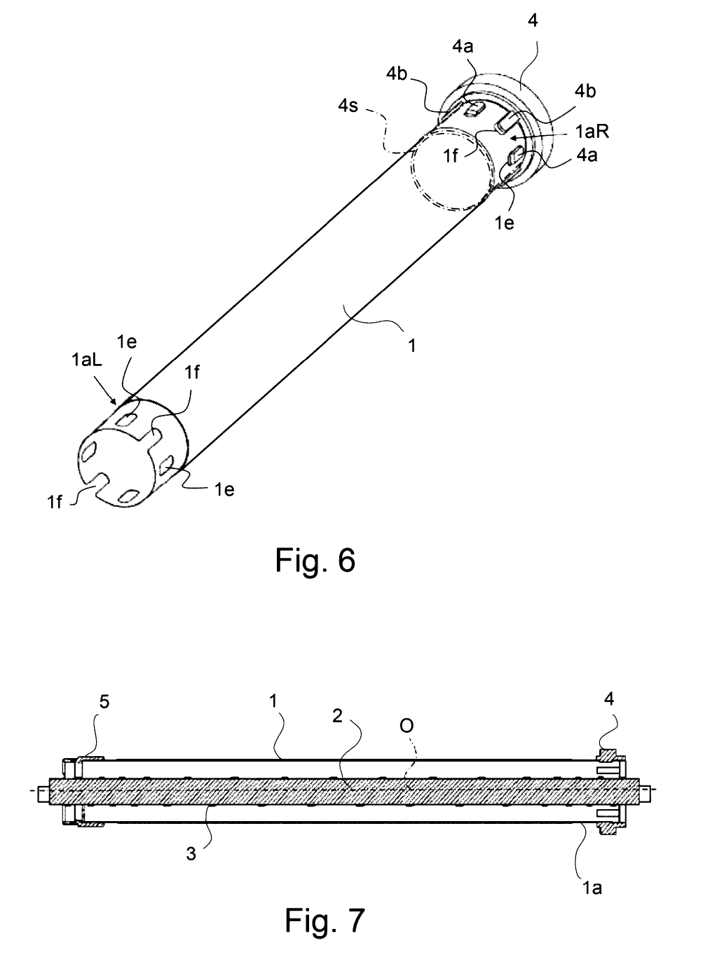

Shown in FIG. 6 is an example of modified version of the combination of the fixation roller 1 and driving gear 4. In this embodiment, the driving gear 4 is fitted around the outward side of the right end portion 1aR of the conductive layer 1a of the fixation roller 1. However, the combination may be structured so that a part of the driving gear 4 is inserted into the right end portion 1aR of the conductive layer 1a of the fixation roller 1, as shown in FIG. 6. In the case of this example of modification, the driving gear 4 is provided with a cylindrical supporting portion 4s for supporting the right end portion 1aR of the conductive layer 1a of the fixation roller 1, and this cylindrical supporting portion 4s is inserted into the right end portion 1aR of the conductive layer 1a in such manner that the multiple claws 4a and the multiple ribs 4b fit into the holes 1e and slots 1f of the fixation roller 1, respectively.

In this embodiment, the fixing device 20 is structured so that the driving gear 4 is attached to the fixation roller 1. However, the application of the present invention is not limited to a cylindrical rotational member to a fixation roller such as the fixation roller 1 in this embodiment. That is, the present invention is applicable to any cylindrical rotational member having a thin wall.

Next, the opposite lengthwise end portion 1aL (which hereafter will be referred to as “not-driven end portion”) of the fixation roller 1 from the one fitted with the driving gear 4, that is, the lengthwise end portion 1aR (which hereafter will be referred to as “driven end portion”) of the fixation roller 1, from which the fixation roller 1 is not driven, is described.

The fixation roller 1 is roughly symmetrical with reference to its lengthwise center. That is, the not-driven end portion 1aL of the fixation roller 1 is provided with holes 1e and slots 1f as is the driven end portion 1aR. This setup is for equalizing the driven end portion 1aR and not-driven end portion of the fixation roller 1 in the manner in which heat is generated therein by electromagnetic induction, which is described later. By equalizing the two end portions 1aR and 1aL in the manner of heat generation, it is possible to minimize the amount by which heat is generated in the driven end portion 1aR and not-driven end portion 1aL, which are out-of-sheet-path portions of the fixation roller 1.

To the not-driven end portion 1aL, a round cap 5 is attached as a capping member. Shown in FIG. 5 are the keys, with which the cap 5 is provided and, the key slots with which the not-driven end portion 1aL of the fixation roller 1 is provided.

The cap 5 is provided at the center thereof with a cylindrical hole 5h, which is coaxial with the cap 5 and the diameter of which is slightly larger than the external diameter of the conductive layer 1a. The cap 5 is structured so that the multiple ribs 5a, which are formed on the inner surface of the cap 5 and are shaped like a key, fit into the multiple slits 1f, one for one, with which the not-driven end portion 1aL of the fixation roller 1 is provided. This cap 5 is attached to the not-driven end portion 1aL in such a manner that it is allowed to slide in the direction parallel to the axial line O of the fixation roller 1 to be easily attached to, or unattached from, the fixation roller 1, because, if the cap 5 cannot be removed, the space through which the components to be placed in the hollow of the fixation roller 1 during the assembly of the fixation roller 1 will be smaller.

Unlike the driving gear 4, the cap 5 is not given the function of transmitting a large amount of driving force (toque). Therefore, it is unlikely that the fixation roller 1 is damaged by the stress to which the fixation roller 1 is subjected as the fixation roller 1 is rotated.

The cap 5 is attached to the fixation roller 1 in the following manner. First, the cap 5 is positioned so that its keys are aligned with the key slots of the not-driven end portion 1aL of the fixation roller 1. Then, the cap 5 is fitted around the not-driven end portion 1aL in the direction indicated by an arrow mark Yb which is parallel to the axial line O of the fixation roller 1. The position of the cap 5 relative to the fixation roller 1 in terms of the direction in which the cap 5 is moved to be fitted around the not-driven end portion 1aL is determined by the contact between the downstream end (surface) 5a1 of the rib 5a in terms of the direction in which the cap 5 is moved to be fitted around the not-driven end portion 1aL, and the farthest end 1f1 of the slot 1f from the lengthwise end 1dL of the fixation roller 1. That is, in terms of the direction Yb in which the cap 5 is moved to be fitted around the not-driven end portion 1aL, each rib 5a is long enough to extend from the lengthwise end 1dL to come into contact with the farthest end 1f1 of the corresponding slot 1f from the lengthwise end 1dL.

### 2-3) Pressure Belt Unit 9

Referring to FIG. 2, the pressure belt unit 9 has a pressure belt 7, which is an endless belt and is rotated by the rotation of the fixation roller 1. There is disposed a pressure pad 8 on the inward side of the loop which the pressure belt 7 forms. The pressure pad 8 contacts the inward surface of the pressure belt 7. It is supported by a rigid supporting member 6b, which is U-shaped in cross section. It presses on the fixation roller 1 from the inward side of the pressure belt loop, with the presence of the pressure belt 7 between itself and the fixation roller 1.

The pressure belt 7 does not need to be laminar. In this embodiment, however, a laminar endless belt, which has a substrative layer, and a release layer formed on the surface of the substrative layer, is used as the pressure belt 7. As the material for the substrative layer, a heat resistant substance such as thermally curable polyimide, thermoplastic polyimide, polyamide, polyamideimide, and the like is used. As for the material for the release layer, a substance, to which toner is unlikely to remain adhered, is desirable. For example, fluorine resin such as PTFE (polytetrafluoroethylene), PFA (tetrafluoroethylene-perfluoroalkoxylethylene copolymer) is used.

The primary role of the pressure pad 8 is to make the fixation roller 1 and pressure belt 7 form a nip N between them. As the material for the pressure pad 8, a rigid substance such as metal, more specifically, aluminum, stainless steel, steel, copper, brass, etc., their alloys, or resins, which are highly rigid are primarily used. In this embodiment, a pad formed of liquid polymer by injection molding and reinforced by glass fiber was used as the pressure pad 8. Therefore, it is ensured that the pressure pad 8 in this embodiment is provided with a proper amount of rigidity in terms of the direction perpendicular to the lengthwise direction of the nip N.

### 2-4) Structure of Heating Means H

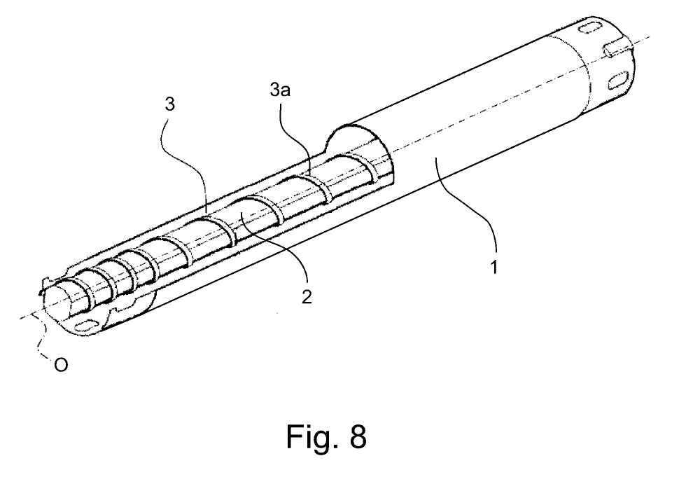

FIG. 7 is a sectional view of a combination of the fixation roller 1 and a heating means H disposed in the hollow of the fixation roller 1. FIG. 8 is a perspective cutaway view of the fixation roller 1. It shows a part of the heating means H.

The heating means H has a magnetic core 2 and an excitation coil 3. The magnetic core 2 is cylindrical. It is disposed roughly at the center of the hollow of the fixation roller 1, being held by an unshown fixing means. The role of the magnetic core 2 is to guide the magnetic flux of the alternating magnetic field generated by the excitation coil 3, into the inward side of the conductive layer 1a (area between conductive layer 1a and magnetic core 2). That is, it is to form a passage (magnetic passage) for the magnetic flux.

As the material for the magnetic core 2, a substance, such as ferrite made by sintering, and ferrite resin, amorphous metallic alloy, which is small in hyteresis loss, and high in relative magnetic permeability, or a ferromagnetic substance, such as Permalloy or the like oxide (which is high in magnetic permeability), is desirable. In particular, in a case where high frequency alternating current, that is, alternating current which is 21 kHz-100 kHz in frequency, is flowed through the excitation coil 3, ferrite which is made by sintering and is small in loss when high frequency alternating current is flowed, is desirable.

The magnetic core 2 is desired to be as large as possible in cross section, as long as it can be disposed in the hollow of the conductive layer 1a. In this embodiment, the magnetic core 2 is 5 mm-40 mm in diameter, and 230-300 mm in length in terms of the direction perpendicular to the recording medium conveyance direction X. By the way, it is not mandatory that the magnetic core 2a is in the form of a piece of round column. It may be in the form of a piece of column which is polygonal in cross section.

The excitation coil 3 is formed by spirally winding copper wire (single wire) which is coated with heat resistant polyamide and 0.5-2.0 mm in diameter, around the magnetic core 2 roughly 10-100 times. It has a spiral portion 3a, the axial line of which is roughly parallel to the generatrix of the fixation roller 1. In this embodiment, the excitation coil 3 is wound 16 times. The excitation coil 3 is wound in the direction which is intersectional to the axial line of the fixation roller 1. Therefore, as high frequency alternating current is flowed through the excitation coil 3, an alternating magnetic field which is parallel to the axial line of the conductive layer 1a is generated.

### (3) Heat Generation Principle of Heating Means H

### (3-1) Shape of Magnetic Field

The fixing device 20 is provided with the combination of the spiral excitation coil 3 and the magnetic core 2, which are disposed in the hollow of the fixation roller 1, like the fixing device disclosed in Patent Document 2. The excitation coil 3 is disposed in such an attitude that its lengthwise direction is parallel to the axial line of the fixation roller 1. The magnetic core 2 is for guiding the magnetic flux. It is disposed inside the excitation coil 3 to guide the magnetic flux generated by the excitation coil 3 in such a manner that the magnetic flux does not go through the conductive layer 1a of the fixation roller 1.

That is, the primary objective of this embodiment is to create the following state, which may be deemed as an index that indicates how easily magnetism goes through the fixation roller 1 in the lengthwise direction of the fixation roller 1, looking at the fixing device 20 as a magnetic circuit. That is, it is to create such a state that the “the magnetic core 2 is small enough in magnetic resistance in terms of its lengthwise direction, and the conductive layer 1a and the inward adjacencies of the conductive layer 1a are large enough in magnetic resistance”. With the creation of this state, it is possible to provided a fixing device designed so that the magnetic flux concentrates in the magnetic core 2, and does not go through the conductive layer 1a and the inward adjacencies of the conductive layer 1a.

As alternating current is flowed through the excitation coil 3, the conductive layer 1a is subjected to such electromagnetic force that induces electric current in the circumferential direction of the conductive layer 1a. Thus, heat (Joule's heat) is efficiently generated by this current which flows in the circumferential direction of the conductive layer 1a. Unlike the method disclosed in Patent Document 1, this method of generating heat in the conductive layer 1a does not require that the magnetic flux is guided to the conductive layer 1a. Therefore, it is meritorious in that it is relatively small in the amount of restriction regarding the thickness and material of the conductive layer 1a.

### 3-2) Heat Generation Principle of Conductive Layer 1a Having No Slot 1f

Next, the heat generation principle of the conductive layer 1a having no slot 1f is described.

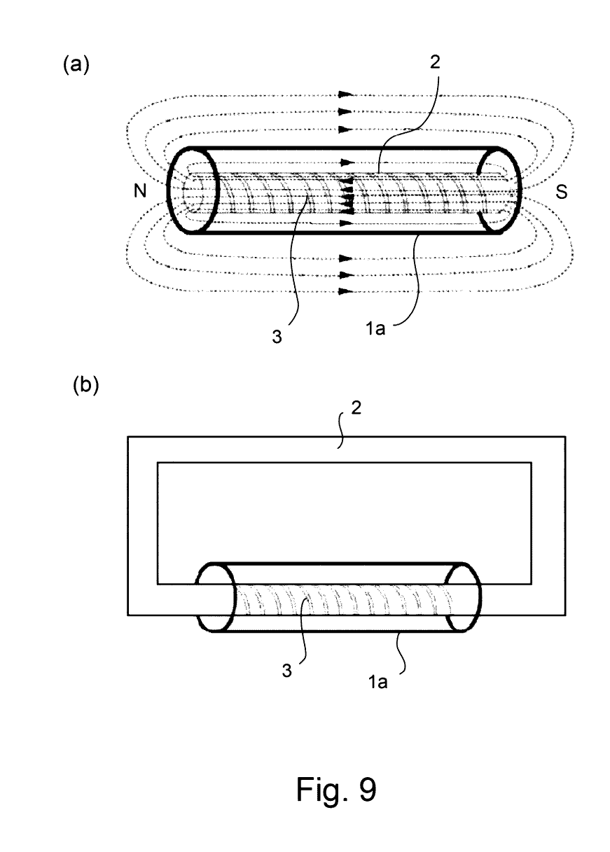

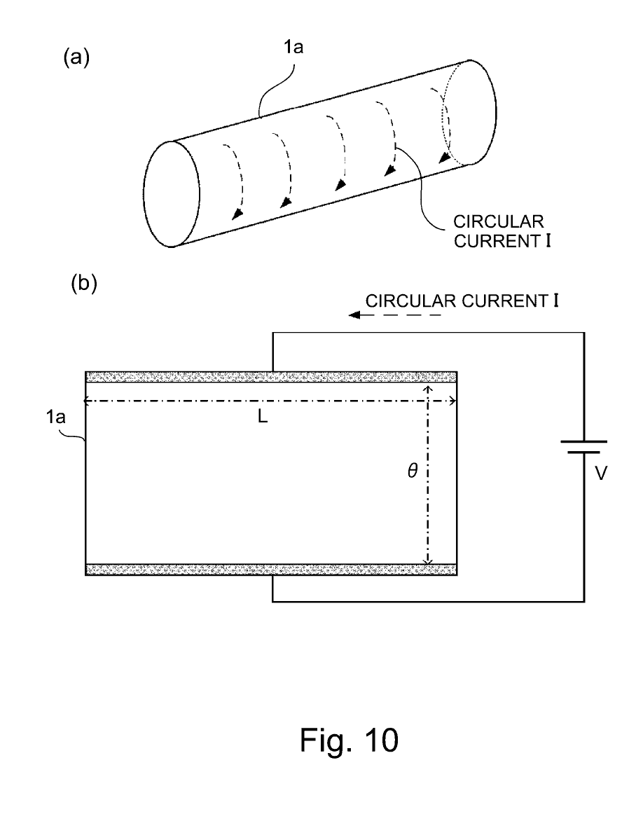

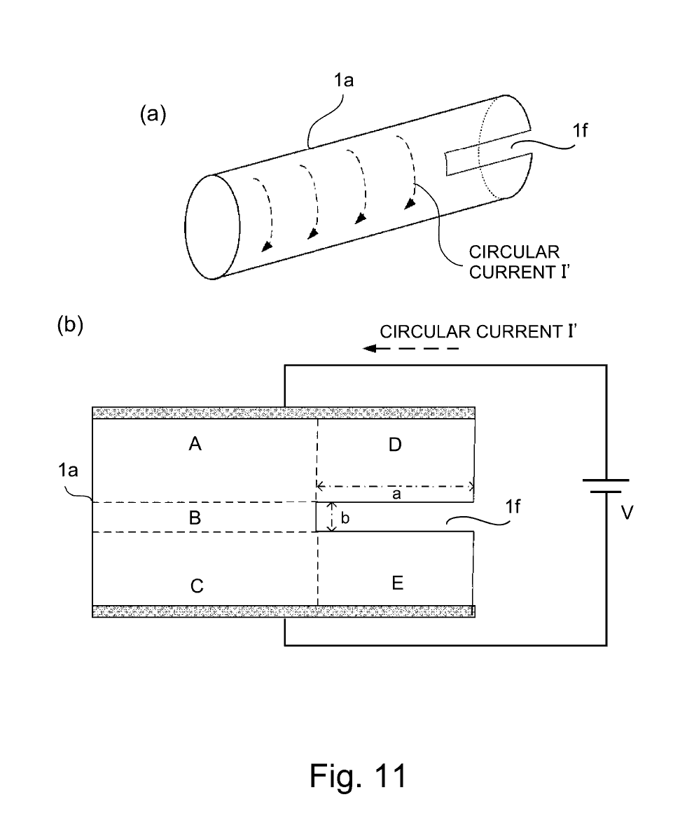

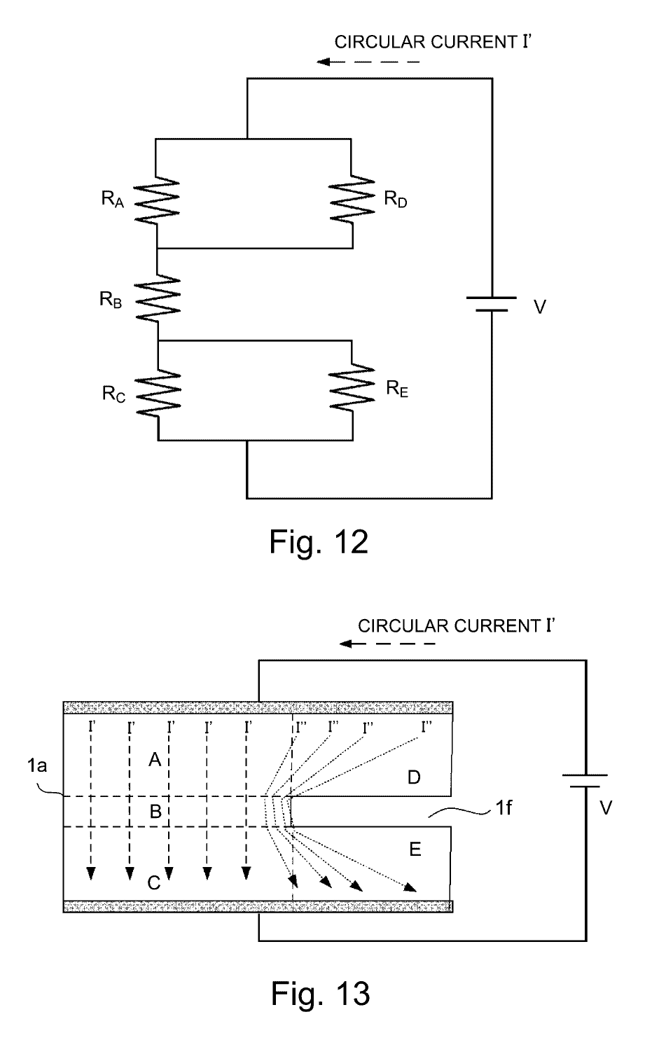

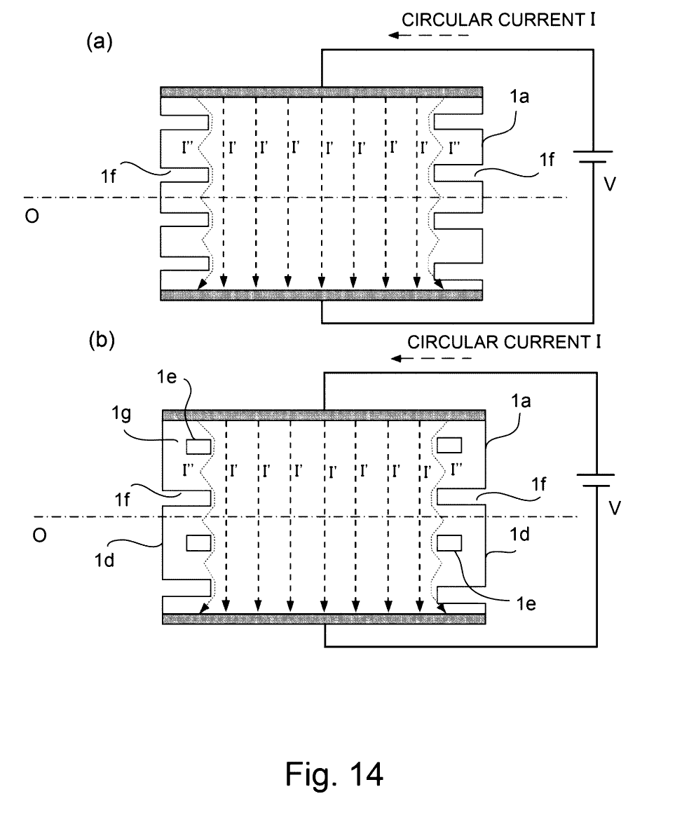

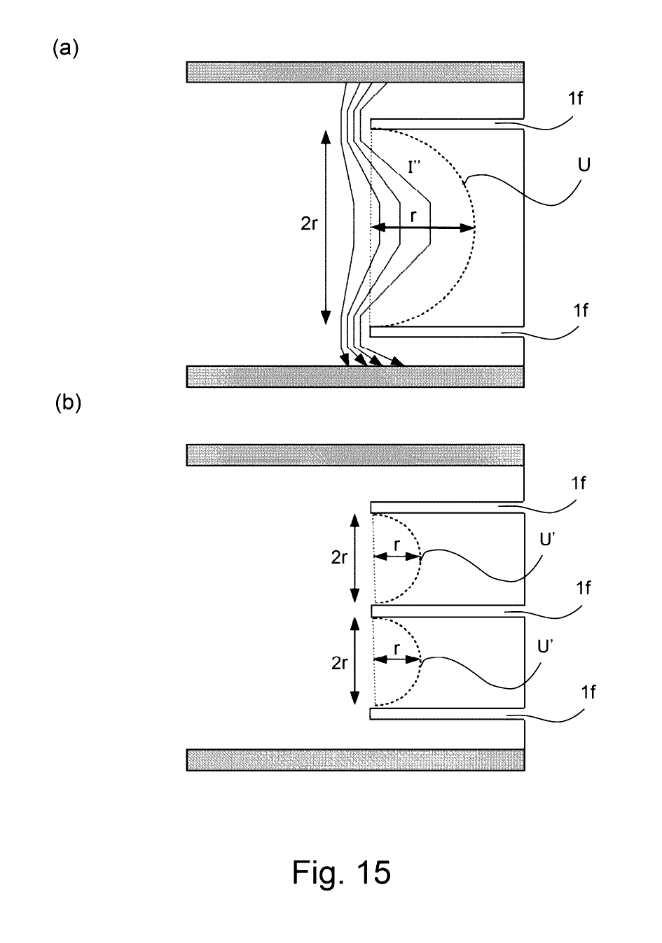

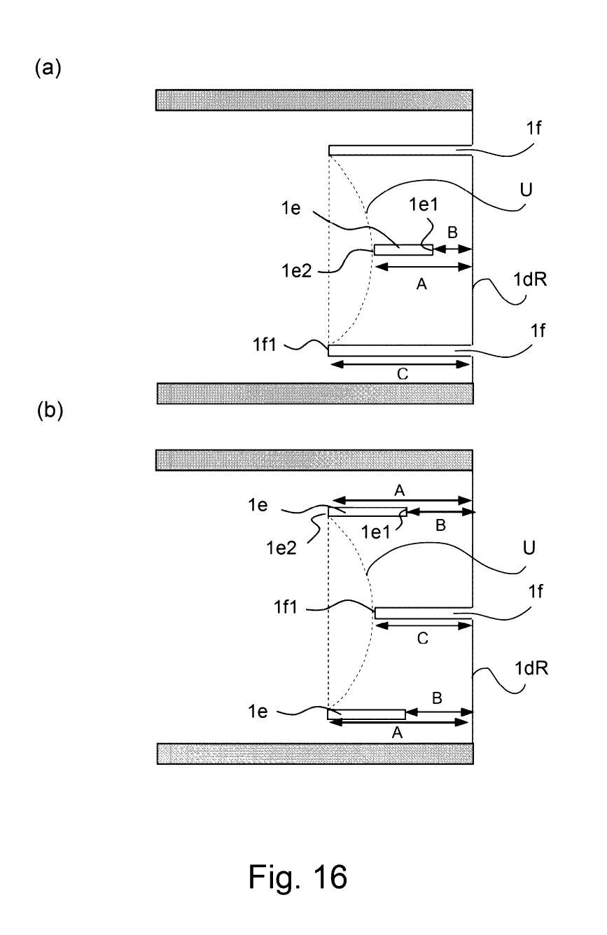

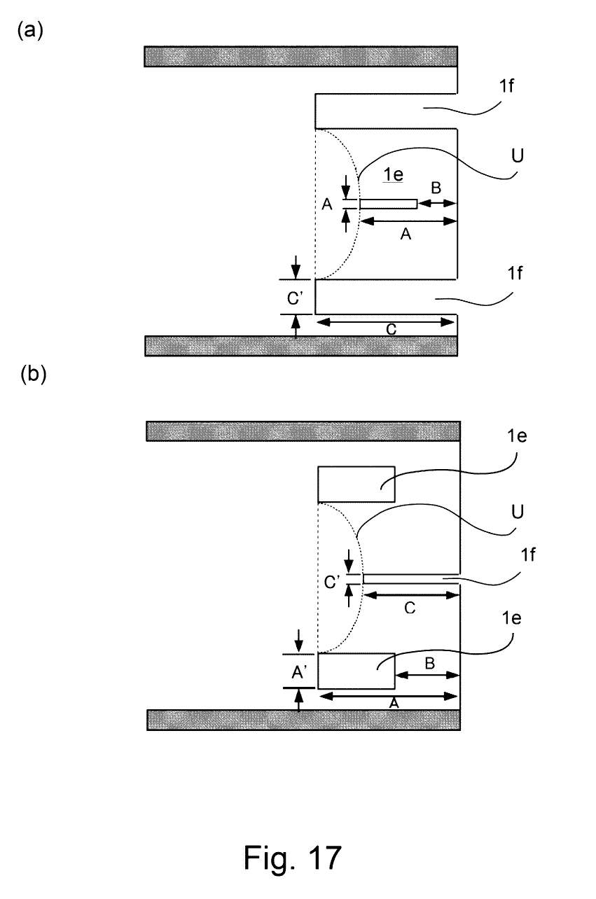

Referring to part (a) of FIG. 9, the heat generation mechanism of the conductive layer 1a is described. The magnetic flux generated by flowing alternating current through the coil 3 permeates through the magnetic core 2 which is in the hollow of the cylindrical conductive layer 1a in the direction (S-to-N direction) parallel to the axial line of the conductive layer 1a, comes out of the conductive layer 1a from one (N) of the lengthwise ends of the magnetic core 2, and returns to the other end (S). Thus, current is induced in the direction to counter the fluctuation (increase and decrease) of the magnetic flux which is permeating through conductive layer 1a in the direction parallel to the axial line of the conductive layer 1a. Consequently, the current flows through the conductive layer 1a in the circumferential direction of the conductive layer 1a, generating heat (Joule's heat) in the conductive layer 1a. That is, heat is generated in the conductive layer 1a by electromagnetic induction.

The amount of this current-inducing electric power (V) which is generated in the conductive layer 1a is proportional to the amount (Δφ/Δt) by which the magnetic flux fluctuates per unit length of time while permeating through the conductive layer 1a, and the number N of windings of the magnetic coil 3, as expressed by the following Equation (1).

$$V = - N \frac{Δ Φ}{Δ t} \qquad ( 1 )$$

There is a correlation between the ratio of the magnetic fluxes which take the outside route, relative to the entirety of the magnetic fluxes which come out of one of the lengthwise ends of the magnetic core 2, and the amount (electric power conversion efficiency) by which the electric power inputted into the coil 3 is consumed for the heat generation in the conductive layer 1a. Thus, the amount by which the electric power inputted into the coil 3 is consumed for the heat generation is a very important parameter. The greater the ratio of the magnetic fluxes which take the outside route, the higher the ratio with which the electric power inputted into the coil 3 is consumed for the heat generation in the conductive layer 1a (higher the power conversion efficiency). The reason for the occurrence of this phenomenon is the same in principle as the phenomenon that, provided that a transformer is negligibly small in magnetic flux leakage, the transformer is higher in power conversion efficiency if the number of magnetic fluxes which pass through the primary coil of the transformer is equal to the number of magnetic fluxes which pass through the secondary coil.

That is, in the case of this embodiment, the closer the number of magnetic fluxes which pass through the core 2 to the number of magnetic fluxes which takes the outside route, the higher the fixation roller 1 in power conversion efficiency. That is, the high frequency current which is flowed through the coil 3 can be efficiently converted into such current that flows through the conductive layer 1a in the circumferential direction of the conductive layer 1a, for the following reason.

That is, referring to part (a) of FIG. 9, the magnetic fluxes which pass through the core 2a are opposite in direction from the magnetic fluxes which take the inside route. Thus, if the number of the magnetic fluxes on the inward side, inclusive of the magnetic core 2, of the cylindrical conductive layer 1a is the same as the number of the magnetic fluxes on the outward side of the cylindrical conductive layer 1a, these magnetic fluxes cancel each other. Thus, the number of magnetic fluxes which pass through the entirety of the inward side of the conductive layer 1a from S to N is reduced, and therefore, the changes which occur to the magnetic field per unit length of time reduces. As the magnetic field reduces in the amount of change per unit length of time, the amount by which current is induced in the conductive layer 1a reduces, which results in reduction in the amount by which heat is generated in the conductive layer 1a.

It is evident from what was described in the foregoing that it is important for the fixing device 20 to be controlled in the ratio of the magnetic fluxes which take outside route, in order to achieve a desired power conversion ratio.

It is not mandatory that the magnetic core 2 is in the form of a piece of round column. For example, the magnetic core 2 may be in the form of a rectangular frame, a section of which is put though the hollow of the conductive layer 1a as shown in part (b) of FIG. 9.

### 3-3) Circuit Equivalent in Current Flow to Conductive Layer of Fixation Roller 1

Part (a) of FIG. 10 is a perspective view of the slot-less conductive layer 1a. According to the structure of the heating means H in this embodiment, as the conductive layer 1a is subjected to power generating force which works in the circumferential direction of the conductive layer 1a, current I flows in the conductive layer 1a in the direction indicated by arrow marks. Part (b) of FIG. 10 is a circuit which is equivalent to a circuit created by flattening the cylindrical conductive layer 1a by cutting the cylindrical conductive layer 1a in the direction parallel to the axial line of the conductive layer 1a, and applying DC voltage between the two edges created by the cutting. In this case, overall amount of resistance R of the conductive layer 1a can be expressed in the form of the following Equation (2), in which L, θ, d and ρ stand for the length of the conductive layer 1a in terms of the direction parallel to the axial line of the conductive layer 1a, circumference of the conductive layer 1a, thickness of the conductive layer 1a, and electrical resistivity of the conductive layer 1a, respectively.

$$R = \frac{θ}{Ld} ρ \qquad ( 2 )$$

Therefore, if the conductive layer 1a in part (b) of FIG. 10 is subjected to the power generating force V, the overall amount W by which heat is generated in the conductive layer 1a, and the amount w by which heat is generated in conductive layer 1a per unit volume of the conductive layer 1a, can be calculated by the following Equations (3) and (4), respectively.

$$\begin{matrix}W = \frac{{V}^{2}}{R} = \frac{Ld}{θ} \frac{{V}^{2}}{ρ} & ( 3 ) \\ ω = \frac{W}{θ Ld} = \frac{1}{{θ}^{2}} \frac{{V}^{2}}{ρ} & ( 4 )\end{matrix}$$

3-4) Principle Based on which Slots Prevent Heat from being Excessively Generated in Conductive Layer

Next, the principle based on which heat is generated in conductive layer 1a of fixation roller 1, which has slots 1f, is described.

3-4-1) Principle Based on which Slots Prevent Heat from Excessively Generated in Conductive Layer

Next, regarding a fixing device, like the fixing device 20 in this embodiment, the fixation roller 1 of which is heated by the heat generated therein by the current which flows through its conductive layer 1a in the circumferential direction of the fixation roller 1, the principle based on which the distribution of slots across the lengthwise end portions of the fixation roller 1 in terms of the circumferential direction of the fixation roller 1 prevents the lengthwise end portions from being excessively heated, is described with the use of the calculation made with reference to an electrical circuit equivalent in current flow to the fixation roller 1, by comparing a fixation roller, the cylindrical conductive layer 1a of which has slots and a fixation roller, the cylindrical conductive layer 1a of which does not have slots.

part (a) of FIG. 11 is a schematic perspective view of a cylindrical conductive layer 1a of the fixation roller 1, shown in part (a) of FIG. 10, which has only one slot 1f. As the conductive layer 1a structured as shown in part (a) of FIG. 10 is subjected to the power generating force V which works in the circumferential direction of the conductive layer 1a, current I′ flows through the conductive layer 1a in the direction indicated by arrow marks in part (a) of FIG. 11. Part (b) of FIG. 11 is a drawing of an electrical circuit which is equivalent in current flow to the circuit made by flattening the cylindrical rotational member 1a by cutting the rotational member 1a in the direction parallel to the axial line of the rotational member 1a and attaching a power generating means to the flattened rotational member power so that DC voltage is applied between the two edges of the flattened rotational member, which are parallel to the rotational axis of the rotational member 1a.

Referring to part (b) of FIG. 11, “a” stands for the dimension (depth) of the slot 1f in terms of the direction parallel to the axial line of the cylindrical rotational member 1a, and “b” stands for the dimension (width) of the slot 1f in terms of the circumferential direction of the cylindrical rotational member 1a. It is reasonable to suppose that the flattened cylindrical member 1a comprises five zones (areas) A-E. If it is assumed here that the five zones A-E have electrical resistances RA-RE, and also, that it is only the current which flows through the conductive layer 1a in the circumferential direction of the conductive layer 1a that contributes to the heat generation in the conductive layer 1a, part (b) of FIG. 11 can be approximately redrawn as the electrical circuit shown in FIG. 12. The overall amount R′ of electrical resistance of the conductive layer 1a in FIG. 12 is expressible in the form of Equation (5).

$${R}^{′} = \frac{{R}_{A} {R}_{D}}{{R}_{A} + {R}_{D}} + {R}_{B} + \frac{{R}_{C} {R}_{E}}{{R}_{C} + {R}_{E}} \qquad ( 5 )$$

In the case of the conductive layer 1a shown in part (a) of FIG. 11, the number of the slot 1 is only one. Therefore, if it is assumed here that the slot 1 is at the center of the conductive layer 1a in terms of the circumferential direction of the conductive layer 1a, the electrical resistances RA-RE are expressible in the form of the following equations (6)-(8).

$$\begin{matrix}{R}_{A} = {R}_{C} = \frac{θ - b}{2 ( L - a ) d} ρ & ( 6 ) \\ {R}_{B} = \frac{b}{( L - a ) d} ρ & ( 7 ) \\ {R}_{D} = {R}_{E} = \frac{θ - b}{2 ad} ρ & ( 8 )\end{matrix}$$

By substituting RA-RE in Equation (5) with Equations (6)-(8), R′ can be simplified as Equation (9).

$${R}^{′} = \frac{( L - a ) θ + ab}{( L - a ) Ld} ρ \qquad ( 9 )$$

Therefore, the amount by which heat is generated by the overall amount R′ of electrical resistance in FIG. 12, that is, the overall amount W by which heat is generated in the conductive layer 1a as the conductive layer 1a in part (b) of FIG. 11 is subjected to the power generating force V is expressed in the form of Equation (10).

$${W}^{′} = \frac{{V}^{2}}{{R}^{′}} = \frac{( L - a ) Ld}{( L - a ) θ + ab} \frac{{V}^{2}}{ρ} \qquad ( 10 )$$

There is the following relationship, expressible in the form of Expression (11), between the amount W′ (Equation (10)) by which heat is generated in the conductive layer 1a having the slot 1f and the amount W (Equation 3) by which heat is generated in the conductive layer 1a having no slot, provided that both conductive layers 1a are subjected to the same amount of power generating force V.

$$\frac{{W}^{′}}{W} = \frac{( L - a ) θ}{( L - a ) θ + ab} < 1 ( ∵ ab > 0 ) \qquad ( 11 )$$

Based on Expression (11), W′<W. Thus, it is proven that the presence of the slot 1f can prevent the generation of an unnecessary amount of heat.

### 3-4-2) Principle of Excessive Amount of Heat Generation in Adjacencies of Inward End of Slot 1f of Conductive Layer 1a

In the case of an electrical circuit such as the one shown in part (b) of FIG. 11, the presence of the slot 1f reduces the overall amount by which heat is generated in the conductive layer 1a. On the other hand, the presence of the slot 1f causes the current generated in the zones D and E to circumvent the slot 1f. That is, the presence of the slot 1f generates current I″ which flows through the right end portion of the zone B. Therefore, the right end portion (adjacencies of inward end 1f) of the zone B increases in the amount of current, and therefore, increases in the amount by which heat is generated therein. If the amount by which heat is generated in the right end portion of the zone B becomes substantial, it will possibly lead to such problems as the damages to the fixation roller 1, in particular, the key portions of the fixation roller 1.

(4) Method which Relies on Shape and Positioning of Slot to Prevent Adjacencies of Inward End of Slot from Generating Heat

Referring to part (a) of FIG. 14, cutting multiple slots 1f in the lengthwise end portions of the conductive layer 1a in such a pattern that the slots 1f distributed in the circumferential direction of the conductive layer 1a can effectively reduce the amount by which the current I″ (which hereafter will be referred to as circumventive current, hereafter) is generated in a manner to circumvent (detour around) the slots 1f. Therefore, it can prevent the problem that the fixation roller 1 is damaged by the excessively large amount of heat generated by the excessively large amount of current generated in the adjacencies of the inward end of the slots 1f.

The greater the number of slots 1f, the more effectively the current is prevented from being generated in a manner to circumvent the slot 1f through the adjacencies of the inward end of each slot 1f. However, the greater the number of slots 1f, the weaker the lengthwise end portions of the fixation roller 1. Besides, as rotational force is transmitted from the driving gear 4 to one of the lengthwise ends of the fixation roller 1, this force works in a manner to widen the slots 1f. Therefore, increasing the lengthwise end portions of the fixation roller 1 in the number of slots 1f is problematic in that the greater the number of slots 1f, the weaker the lengthwise end portions of the fixation roller 1, and therefore, more likely it is for the fixation roller 1 to be damaged by the driving force from the driving gear 4.

4-1) Method for Minimizing Amount by which Adjacencies of Slots 1f are Reduced in Mechanical Strength

Referring to part (b) of FIG. 14, one of the methods for preventing the above described problem is to provide the lengthwise end portions of the conductive layer 1a with a combination of multiple slots 1f, the long edges of which are parallel to the axial line O of the conductive layer 1a, and multiple elongated holes, the long edges of which are parallel to the axial line O of the conductive layer 1a, and position the slots 1f and holes 1d so that they are alternately and evenly distributed in the circumferential direction of the conductive layer 1a.

With the fixation roller 1 being structured as described above, it is possible to effectively prevent the occurrence of the “circumventive current”, while minimizing the amount by which the is adjacencies of the inward end of the slots 1f are reduced in strength by the structural arrangement for the prevention of the occurrence of the “circumventive current”. From the standpoint of reducing the occurrence of the “circumventive current”, this structural arrangement is as effective as eight slots 1f. That is, in the case of this structural arrangement, the adjacencies of each hole 1e of the conductive layer 1a is contiguous with the edge 1dR. Thus, it is meritorious in that it provide the lengthwise end portions of the conductive layer 1a with a sufficient amount of mechanical strength.

Further, as described above, this structural arrangement can improve the fixing device 20 in accuracy in terms of the positional relationship between the fixation roller 1 and driving gear 4 in terms of the lengthwise direction of the fixation roller 1. Therefore, it can ensure that in terms of the direction in which the claws 4a and ribs 4b of the driving gear 4 are inserted into the holes 1d and slots 1f of the fixation roller 1, respectively, the position at which driving force is transmitted from the driving gear 4 to the fixation roller 1 always remains the same. Therefore, the amount of the stress, to which the edge of each hole 1d of the fixation roller 1 is subjected, remains stable. Therefore, this structural arrangement can prevent the driven end portion 1aR of the fixation roller 1 from being damaged by the stress.

Further, the fixing device 20 is structured so that while the fixation roller 1 is rotationally driven by the driving gear 4, which is a bevel gear, the fixation roller 1 remains pressed toward the driving gear 4. Therefore, the fixing device 20 remains stable in the positional relationship among the fixation roller 1, core 2, and coil 3 in terms of the lengthwise direction of the fixing device 20. Therefore, the driven end portion 1aR and not-driven end portion 1aL of the fixation roller 1, which are the out-of-sheet-path portions B of the lengthwise end portions of the fixation roller 1, remain the same in the state of heat generation. That is, this embodiment (present invention) can simplify the means for preventing the out-of-sheet path portions of the fixation roller 1 from becoming excessively high in temperature and/or nonuniform in temperature.

Therefore, even if a piece of metallic cylinder, which is thin, and therefore, is small in thermal capacity, is used as the conductive layer for a fixation roller, it is possible to realize such a fixation roller that, the lengthwise end portions of which are shaped so that they are not damaged by a large amount of torque; the adjacencies of the inward end of the slot (key slot) are not overheated by the concentration of current thereto; and the out-of-sheet-path portions B are minimized in the amount of heat generation. Therefore, it is possible to provide an image forming apparatus which requires a significantly shorter length of time to warm up, and smaller in power consumption than any conventional image forming apparatus, by installing the fixing device 20 equipped with the fixation roller 1 in this embodiment, in the apparatus.

### Embodiment 2

In the first embodiment, the lengthwise end portions of the conductive layer 1a are provided with the multiple elongated holes 1e and multiple elongated slots 1f, the lengthwise edges of which are parallel to the axial line O of the conductive layer 1a, and which are alternately and roughly evenly distributed in the circumferential direction of the conductive layer 1a. Therefore, it was possible to minimize the amount of the current which circumvent the holes 1e and slots 1f, while minimizing the amount by which the lengthwise end portions of the conductive layer 1a are reduced in mechanical strength by the provision of the holes 1e and slots 1f. By the way, this embodiment is an example of modification of the first embodiment. This embodiment relates to a method which can effectively prevent the adjacencies of the inward end of the slot 1e from generating an excessive amount of heat, with the modification of the hole 1e and slot 1f in properties.

1) Amount of Circumventive Current I″ and Size of Area of Lengthwise End Portion of Conductive Layer 1a, Through which Circumventive Current I″ Flows

Roughly speaking, there is a correlation between the amount of the circumventive current I′ and the size of the area through which the circumventive current flows. Part (a) of FIG. 15 is a schematic drawing in which the area through the circumventive current can flow is simply indicated by a semicircle, the size of which corresponds to the size of the area through which the circumventive current flows. If the distance between adjacent two slots is 2r, the size of a semicircle U indicated by a dotted line is πr²/2. Referring to part (b) of FIG. 15, if the conductive layer 1a is doubled in the number of slots, the distance between adjacent two slot is reduced to ½. Thus, the sum of the two semicircles U′ contoured by dotted lines reduces to ½. Tests indicate that the amount by which the amount by which heat is generated in the conductive layer 1a by electromagnetic induction is reduced by the circumventive current I″ is equivalent to the amount by which the area through the circumventive current can flow is reduced in size as shown in FIG. 15.

The inventors of the present invention confirmed, from the studies of the thermography of the conductive layer 1a obtained when the coil, core, and conductive layer were disposed in the positional relation shown in FIG. 7, that as the conductive layer 1a was doubled in the number of slots, the size of the current path roughly matched the size of a combination of the semicircles (models) shown in part (b) of FIG. 15, and also, that the speed with which the adjacencies of the inward end of the slot increase in temperature was roughly halved.

2) Case in which Conductive Layer 1a is Provided with Combination of Holes 1e and Slots 1f

A case in which a hole 1e is placed between the two slots 1f is described. It is assumed here that the distance between the lengthwise right end 1dR of the conductive layer 1a and the farthest edge 1e2 of the hole 1e is A; the distance between the lengthwise right end 1dR and the closest edge 1e1 of the hole 1e is B; and the distance from the lengthwise right end 1dR to the farthest edge 1f1 of the slot 1f is C. Then, if the slots 1f are relatively long, and therefore, C>A>B, the area U through which the circumventive current can flow, as shown in part (a) of FIG. 16, is smaller than the area U shown in part (a) of FIG. 15.

Even if the positional relationship between the slots 1f and hole 1e is different from the one shown in part (a) of FIG. 16, for example, A>C>B, the area U through which the circumventive current I′ can flow can be reduced in size, based on the similar mechanism, as shown in part (b) of FIG. 16, and therefore, it is possible to reduce the speed with which the adjacencies of the inward end of the slot increase in temperature, by reducing the amount of the circumventive current I″.

3) Width of Hole 1e and with of Slot 1f

Next, the relationship between the width of the slot 1f and that of the hole 1e is described. It is assumed here that the width (dimension) of the hole 1e in terms of the circumferential direction of the conductive layer 1a is A′; the width (dimension) of the slot 1f in terms of the circumferential direction of the conductive layer 1a is C′. Then, if the slot 1f is relatively long, and C>A>B, the greater the width C′ as shown in part (a) of FIG. 17, the smaller the area U, compared to the area U in part (a) of FIG. 16.

In a case where the positional relationship between the slot 1f and hole 1e are different, as shown in part (b) of FIG. 17, from the shown in part (a) of FIG. 17, even if A>C>B, the area U where the circumventive current can flow can be reduced in size by increasing the hole 1e in the width A′, because of a mechanism similar to the abovementioned one.

The foregoing can be summarized as follows:

If A>C>B, the area U where the circumventive current I″ can flow can be reduced in size while minimizing the amount by which the lengthwise right portion 1aR is reduced in mechanical strength, by structuring the lengthwise right end portion 1aR so that A′>C′ (A>C>B and A′>C′) is satisfied; and

if C>A>B, the area U where the circumventive current I″ can flow can be reduced in size while minimizing the amount by which the lengthwise right portion 1aR is reduced in mechanical strength, by structuring the lengthwise right end portion 1aR so that C′>A′ (C>A>B and C′>A′) is satisfied.

Therefore, it is possible to provide an image forming apparatus which is significantly smaller in the amount by which the adjacencies of the inward end of the slot 1a becomes excessively heated due to the current concentration to the adjacencies, and also, in the amount of heat generation in the out-of-sheet-path portions of the fixation roller.

### [Miscellanies]

In the first and second embodiment, the image heating device in accordance with the present invention was a fixing device for fixing the unfixed toner image formed on a sheet of recording medium, to the sheet. However, the present invention is also applicable to image heating devices other than those in the first and second embodiments. For example, the present invention is also applicable to a device for reheating a toner image which has been temporarily fixed to a sheet of recording medium, in order to increasing the image in gloss.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-239272 filed on Dec. 8, 2015, which is hereby incorporated by reference herein in its entirety.

What is claimed is:

1. A fixing apparatus for forming an image on a recording material, said fixing apparatus comprising:
a cylindrical rotatable member including an electroconductive layer and provided with a hole portion at least at one of longitudinal end portion;
a driving member engaged with the longitudinal end portion of said rotatable member and configured to rotate said rotatable member, said driving member being provided with a claw portion engaged with said hole portion of said rotatable member;
a coil provided inside said rotatable member and configured to form an alternating magnetic field capable of causing electromagnetic induction heat generation of said electroconductive layer, said coil including a helical configuration portion having a helicity axis extending along a generatrix direction of said rotatable member; and
a magnetic core provided inside said helical configuration portion,
wherein said rotatable member generates heat by a current flowing in a circumferential direction of said rotatable member induced in said electroconductive layer in the alternating magnetic field, and
wherein said rotatable member is provided with a slit at the longitudinal end portion, said slit being disposed at a position different from a position of said hole portion with respect to the circumferential direction of said rotatable member and overlapping said hole portion with respect to a longitudinal direction of said rotatable member.

2. The fixing apparatus according to claim 1, wherein a length A from an end surface of said rotatable member at the longitudinal end to an end surface of said hole portion remotest from the end surface, a length B from the end surface of said rotatable member to an end surface of said hole portion closest to the end surface of said rotatable member, a width A′ of said hole portion measured along a circumferential direction of said rotatable member, a length C of said slit measured along the longitudinal direction of said rotatable member, a width C′ of said slit measured along a circumferential direction of said rotatable member satisfy,
A>C>B, and A ‘>C’, or >B and C′>A′.

3. The fixing apparatus according to claim 1, wherein a plurality of such slits are provided along the circumferential direction of said rotatable member with intervals between adjacent slits.

4. The fixing apparatus according to claim 1, wherein said slit is provided at each of the opposite longitudinal end portions of said rotatable member.

5. The fixing apparatus according to claim 1, wherein said slit and said hole portion are disposed at positions not opposing the recording material.
